(19) United States
(12) Patent Application Publication
(10) Pub. No.: US 2006/0183548 A1
(43) Pub. Date: Aug. 17, 2006

(54) System and method for predicting performance of fantasy athletes

(75) Inventors: David Morris, Danville, CA (US); David M. Krieg, San Francisco, CA (US); Doug Willmarth, McKinney, TX (US); David S. Kievatt, Chicago, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: ASSISTANT GM, LLC

(21) Appl. No.: 11/058,079

(22) Filed: Feb. 15, 2005

(51) Int. Cl. G06F 17/00; G06F 19/00

(52) U.S. Cl. 463/42

(57) ABSTRACT

Disclosed is a system and method for predicting game play performance of a number of sports team players selected for fantasy game play where a winner of the fantasy game play is determined by a fantasy points value. The system includes a remote user device including a display, and a host system operatively coupled to the remote user device via an access network. The host system includes an application server and a database coupled to the application server where the application server is configured to provide a number of numerical performance indexes to a user of the remote user device based on sport team player performance data and game play data. The numerical performance indexes correspond to predicted game play performance of the sports team athletes, where the number of numerical performance indexes are utilized by the user to select a fantasy sports team for fantasy game play.

### CROSS-REFERENCE TO RELATED APPLICATIONS

None

### BACKGROUND OF THE INVENTION

The present invention generally relates to fantasy athlete games, and more specifically, to a system and method for predicting performance of fantasy athletes.

America's enduring passion for professional sports, in combination with the rise of the Internet, spawned the growth of “Fantasy Sports” during the 1990s. Typically, “leagues” of fantasy teams are formed by individuals acting as “fantasy managers” or “fantasy team owners” (hereinafter “users”), each choosing or “drafting” players (hereinafter “players”) from among the real-world professional athletes of the sport of choice. The fantasy teams then compete against each other via the awarding of points to each fantasy team, where the points are based on the performance of each chosen real-world player on a particular game date.

In a typical fantasy football game, for example, points are awarded to a fantasy player for touchdowns, field goals, passes thrown, yards gained, etc., based on the performance of the fantasy player's real-world counterpart on a selected play date. The points for each fantasy player on the fantasy team are totaled, and the total scores for each fantasy team are compared with each other to determine the fantasy league winner.

Professional sports fans organize formal and informal fantasy leagues to demonstrate and sometimes capitalize on their sports knowledge and management acumen. Online fantasy leagues play a major role in servicing the more than 15.8 million fantasy sports users in the United States, typically charging a subscription fee for participation in the online fantasy league.

In order to meaningfully participate in fantasy sports, users must have access to and perform sophisticated analyses of objective, detailed, comprehensive and timely information regarding professional athletes, their past game performances and other relevant indicators of potential success (e.g., location of play, weather conditions, and strength of the opposing team). Major media outlets and fantasy sports groups provide raw statistical information and limited analyses regarding a relatively small number of high-profile professional athletes. Other internet-based businesses provide subjective, fee-based advice in response to specific questions regarding individual professional athletes.

Unfortunately, no prior art method or system provides a comprehensive and fully objective rating system of professional athletes for purposes of fantasy play, utilizing past performance data and other relevant indicators to predict and compare the professional athletes' likely performances on a future play date. Further, no system has been developed to provide comparative performance analyses of professional athletes and details regarding the key success factors with regard to such professional athletes, nor does any current rating or advisory system account for the scoring parameters specific to the Owner's league.

Accordingly, it is the general object of the invention to provide a new and improved method for predicting the future performance of professional athletes for use in the field of fantasy sports.

### SUMMARY OF THE INVENTION

The invention is generally directed to a system and method for predicting the future performance of professional athletes (players), for use in the field of fantasy sports.

The system includes a remote user device having a display, and a host system operatively coupled to the remote user device via an access network. The host system includes an application server and a database coupled to the application server where the application server is configured to provide a number of numerical performance indexes, or a number of individual players' Performance Prediction Indexes (PPIs), to a user of the user device based on sport team player performance data and game play data. The numerical performance indexes correspond to predicted game play performance of the sports team athletes, where the number of numerical performance indexes is utilized by the user to select a fantasy sports team roster for fantasy game play.

The method includes (1) determining an individual player's or position's Fantasy-Points equation, (2) using the player's or positions Fantasy-Points equation, past player performance and play conditions to calculate the player's Predicted Fantasy-Points value, and (3) using comparable league players' performances, normalizing the player's Predicted Fantasy-Points value to form the player's Performance Prediction Index. The player's Performance Prediction Index can then be provided to a user and compared with other players' Performance Prediction Indexes for purposes of predicting the probable future success of players on an upcoming play date, and forming an optimal team roster.

### BRIEF DESCRIPTION OF DRAWINGS

FIG. 1 is a system block diagram of an exemplary Performance Prediction Index system according to an embodiment of the invention.

FIGS. 2-4 are a flowchart of a Performance Prediction Index Access routine that may be performed by an application server of FIG. 1 according to an embodiment of the invention.

### DESCRIPTION OF PREFERRED EMBODIMENT

In general, the embodiments of this invention provide a system and method for predicting the future performance of professional athletes (players) selected by a fantasy team owner (user) for fantasy sport play. More specifically, the embodiments of the invention provide a system and method for predicting a player's future performance based on a player's Performance Prediction Index (PPI), and a method and system for providing one or more player PPI(s) to a user, thereby overcoming problems associated with prior art online fantasy league play. In one embodiment, a player's PPI is calculated by (1) determining the individual player's Fantasy-Points equation, including coefficient values for statistically weighted factors of the Fantasy-Points equation, (2) calculating the player's Predicted Fantasy-Points value based using the player's Fantasy-Points equation and values for game play factors, and (3) calculating the player's Performance Prediction Index using the player's Predicted Fantasy-Point value, normalized using PPI league averages of other players playing the same game play position. Normalization facilitates comparative analysis between two or more players. In addition, a portion of the game play factors most relevant to the calculation of the PPI, identified as Key Success Factors, are communicated to the user.

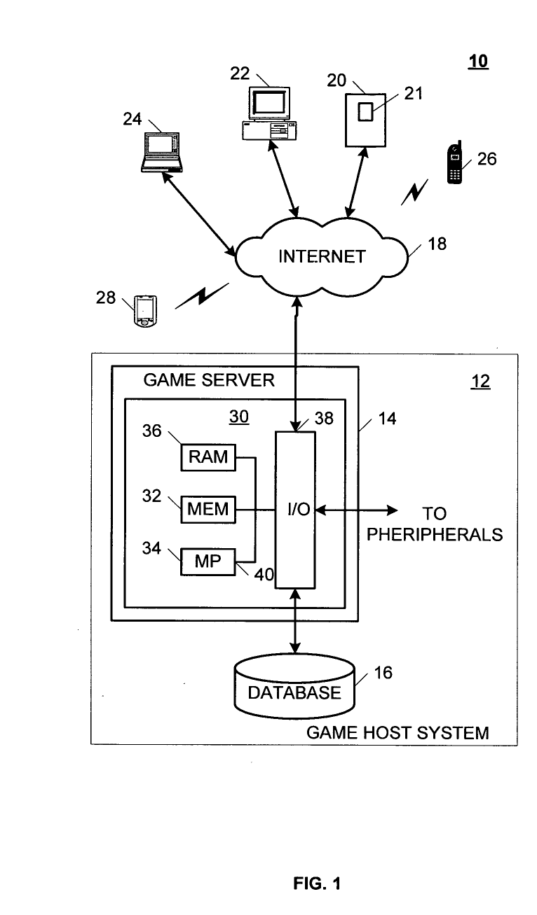

FIG. 1 is a system block diagram of an exemplary Performance Prediction Index (PPI) system 10 according to an embodiment of the invention. Among other things, the Performance Prediction Index (PPI) system 10 is configured to predict a player's future performance based on a player's Performance Prediction Index (PPI) calculated using a novel Fantasy-Point equation including selected factors, statistically weighted for an optimal PPI. Further, the Performance Prediction Index (PPI) system 10 is configured to provide the player PPI(s) and an associated list of the most heavily weighted factors used to determine the player's PPI to a user. The PPIs provided by the PPI system 10 may then be utilized by the user to select a fantasy sports team roster (team roster) that will prevail over opponents' fantasy sports teams.

Referring to FIG. 1, the PPI system 10 includes a host system 12 having an application server 14 coupled to a database 16, and an access network 18 coupling one or more remote user device(s) 20 to the host system 12. The access network 18 enables communication between a remote user device 20, such as a personal computer 22, and the host system 12 for purposes of obtaining performance prediction information associated with players selected for fantasy sports play. Although illustrated as an Internet, the access network 18 may be one of any number of suitable networks enabling communication between the remote user device 20 and the host system 12.

The database 16 is configured to store statistics and information/data regarding players including but not limited to their associated game play factors, their Fantasy-Points equations, their Predicted Fantasy-Points values, their calculated PPIs and to normalize statistics of comparable players.

The remote user device 20 may be one of any number of remote user devices having a display means (display) 21 capable of displaying images received from, or caused to be displayed by, the host system 12. For example, the remote user device 20 may be the personal computer 22, a laptop computer 24, a mobile phone 26, a personal digital assistant (PDA) 28, to name a few. Accordingly, the remote user device 20 may be coupled to the host system 12 via the access network 18 using of one of any number of wireline (e.g., Ethernet) or wireless (e.g., Code Division Multiple Access) methods known in the art.

The application server 14 includes a microcontroller 30 that may include a program memory 32 (including a read only memory (ROM)), a microcontroller-based platform or microprocessor (MP) 34, a random-access memory (RAM) 36 and an input/output (I/O) circuit 38, all of which may be interconnected via a communications link, or an address/data bus 40. In addition, the host system 12 may be in communication with one or more network elements via any suitable network connection such as an Ethernet connection, a modem connection, an 802.11 connection, etc.

The input/output (I/O) circuit 38 provides the interface between the application server 14 and the remote user device(s) 20, and between the application server 14 and the database 16 using one of any number of well known interface protocols. The microprocessor 34 is capable of performing, among other things, calculations of a player's Performance Prediction Index. The RAM 36 is capable of storing data used or generated during calculation of the player's Performance Prediction Index. The program memory 32 is capable of storing program code that calculates the selected player's Performance Prediction Index. For example, based on selected variables and their values, the microprocessor 34, executing code in the program memory 32, determines a specific player's Performance Prediction Index.

In addition to the microcontroller 30, the application server 14 may also include one or more peripheral devices such as a keyboard, a display, a printer, and a mouse, all operatively coupled to the I/O circuit 38. Further, although only one microprocessor 34 is shown, the microcontroller 30 may include multiple microprocessors. Similarly, additional memory (e.g., flash memory) may be included, depending on the requirements of the application server 14. The RAM(s) 36 and program memory(s) 32 may be implemented as semiconductor memories, magnetically readable memories, and/or optically readable memories, etc.

One manner in which the application server 14 of the host system 12 may operate is described below in connection with one or more flowchart(s) that represents a number of portions or routines of one or more computer programs, which may be stored in one or more of the memories of the microcontroller 30. The computer program(s) or portions thereof may also be stored remotely, outside of the application server 14 and may therefore control the operation from a remote location.

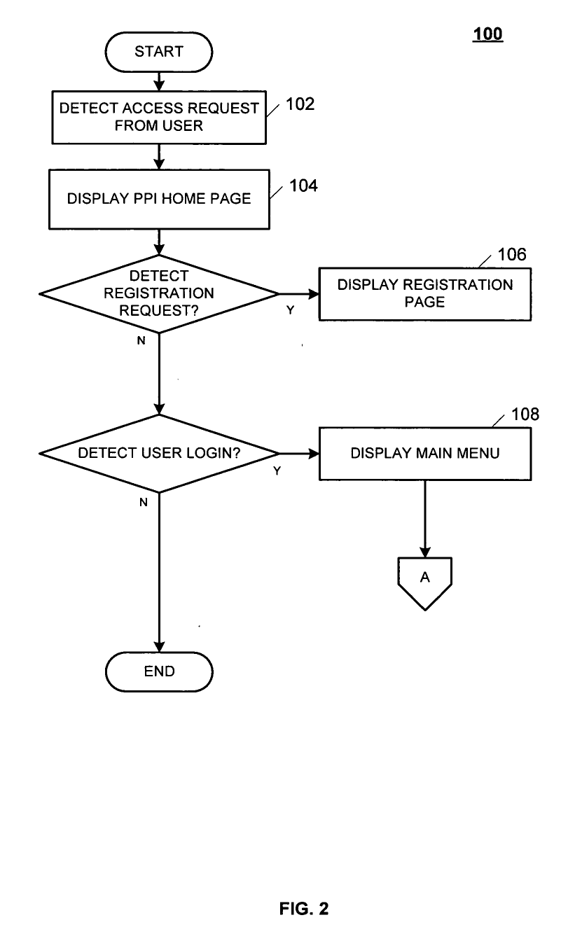

FIGS. 2-4 are a flowchart of a Performance Prediction Index Access routine 100 that may be performed by the host system 12 of FIG. 1. Referring to FIG. 2, the Performance Prediction Index Access routine 100 begins when the microcontroller 30 detects an access request from a user via user entry of the application server's 14 unique Uniform Address Locator by means of a remote user device 20 (step 102). In response to the access request, the microcontroller 30 causes a Performance Prediction Index (PPI) home page to be displayed on the display 21 of the remote user device 20 (step 104). Among others things, the PPI home page is configured to allow the user access to request and obtain one or more player PPIs, to “build” a team roster, and to request and obtain factors most relevant to the calculation of the player PPIs. Such factors most relevant to the calculation of the player PPIs are herein referred to as Key Success Factors. The PPI home page includes a Log-in option selectable by an existing user to access the desired player information, and a Registration option selectable by a new user to register for subsequent access to player information.

When the microcontroller 30 detects new user selection of the Registration option from the PPI home page, the microcontroller 30 causes a Registration page to be displayed to the user via the display means 21 of the remote user device 20 (step 106). The Registration page is configured to allow the user to enter personal and billing information to gain subsequent access to player information. When the microcontroller 30 detects proper log-in information from an existing user, the microcontroller 30 causes a Main Menu page to be displayed to the user via the display means 21 (step 108). Displaying the Main Menu page causes a Compare Player option to be displayed (step 110), a Team Roster option to be displayed (step 112), and an Update Player PPI option to be displayed (step 114).

Among other things, the Main Menu page is configured to allow the user to (1) request player information specific to individual players via the user selectable Compare Players option, (2) to establish and/or modify a team roster via the user selectable Team Roster option, and (3) to update team roster PPI statistics via the user selectable Updated Player PPIs option.

When the microcontroller 30 detects user selection of the Compare Players option from the Main Menu page, the microcontroller 30 causes a number of Compare Player Details drop-down menus to be displayed; a League drop-down menu, a Scoring drop-down menu, a Player Position drop-down menu, and a Player Identification drop-down menu (step 116). The League drop-down menu allows the user to indicate in which league (e.g., Yahoo, ESPN, CBS Sportsline, etc.) he/she participates for fantasy sports play. The Scoring drop-down menu allows the user to select which scoring system is used in the selected league (e.g., yardage, scoring or a combination of both in the case of football). The Player Position drop-down menu allows the user to select a particular player position (e.g., Quarterback). The Player Identification drop-down menu allows the user to select one or more player's names, preferably organized alphabetically according to player positions and player's team(s). Although preferably configured as drop-down menus, it is contemplated that each of the Compare Player Details drop-down menus may be configured in one of any number of well-known user-friendly configurations.

When the microcontroller 30 detects user selection of a league, selection of a type of scoring used, selection of a position of the player and finally, selection of player names via the Compare Player Details drop-down menu, the microcontroller 30 prompts the user to modify his/her choices until the user has selected the players for the user's team roster. Upon detecting user selection of the Team Roster option, the microcontroller 30 displays the user's current team roster via the display 21 (step 118). Using the Compare Player Details menus and the Team Roster option enabling team roster establishment and modification, the user can build or update his/her team roster.

The user has the option to save his/her team roster in the database 16 of the host system 12. Upon detecting user selection of a Save prompt displayed via the Main Menu page, the microcontroller 30 causes the new team roster to be saved in the database 16 (step 120). Similarly, upon detecting user selection of a Email prompt displayed via the Main Menu page, the microcontroller 30 causes the new team roster to be emailed to the remote user device 20 and displayed as a Player Comparison table to the user via the display 21.

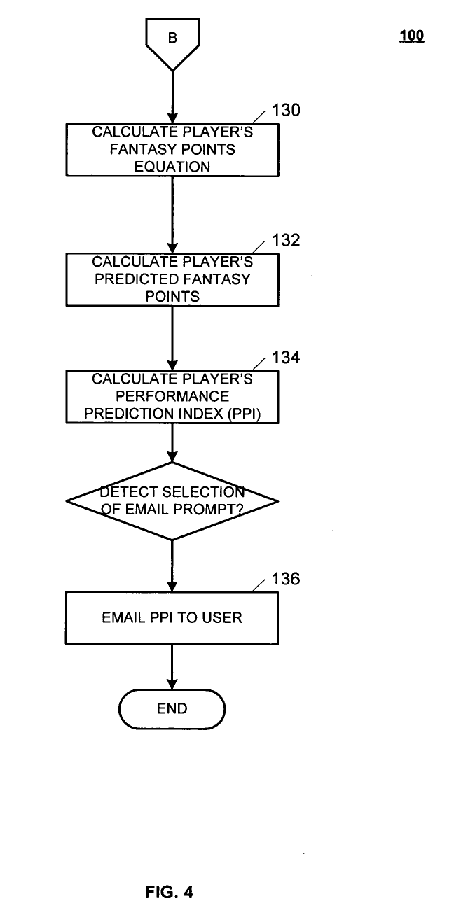

Referring again to step 118, the user has the option of requesting that the PPIs for a player on his/her team roster be calculated. Upon detecting user selection of the Update Player PPI option displayed on the Main Menu page, the microcontroller 30 calculates the PPIs for the players included in that user's team roster (see, FIG. 4) and causes the calculated PPIs to be displayed to the user via the display 21. In addition, the microcontroller 30 causes the factors most relevant (“smack points”) to the calculation of the selected players' PPIs, identified as Key Success Factors, to be displayed to the user via the Player Comparison table.

For example, Table 1 is an exemplary Player Comparison table that may be displayed to the user via the display 21.

TABLE 1

| PLAYER A | PLAYER B | PLAYER C |
|---|---|---|
| Performance Index: | Performance Index: | Performance Index: |
| 115.91 | 104.87 | 86.61 |
| Key Success Factors: | Key Success Factors: | Key Success Factors: |
| Opponents' rushing | Home game | Opponents' Rushing |
| defense | Opponents' passing | Defense |
| Home game | defense | Opponents' passing |
| Forecasted wind speed | Opponents' rushing | defense |
| | defense | Precipitation levels |

As illustrated by Table 1, the user has selected three football Quarterbacks where Player A has a PPI of 115.91, Player B has a PPI of 104.87, and Player C has a PPI of 86.61. As previously mentioned, the PPIs have been normalized such that a PPI of 100 is the average performance index of all NFL/AFL Quarterbacks. Based on the PPIs, one would predict that Player A, with a PPI of 115.91, would render the best performance on the scheduled play date when compared to the performances of Players B and C, and that Player C, with a PPI of 86.61, would render the poorest performance when compared to the performances of Players A and B.

The Player Comparison table displays to the user the Key Success factors which most heavily affect the player's PPI, thereby enabling the user to not only select the best choices for his/her team roster but to be aware of the underlying factors affecting the players PPI. For example, based on Table 1, the user may determine that the Player A's PPI was heavily affected by the relative weakness of the opponent's rushing defense, the fact that Player A is playing in his home arena, and predicted modest wind speeds. On the other hand, the user may determine that Player C's PPI was heavily affected by the strength of the opponent team's rushing and passing defenses, and forecasted high precipitation levels.

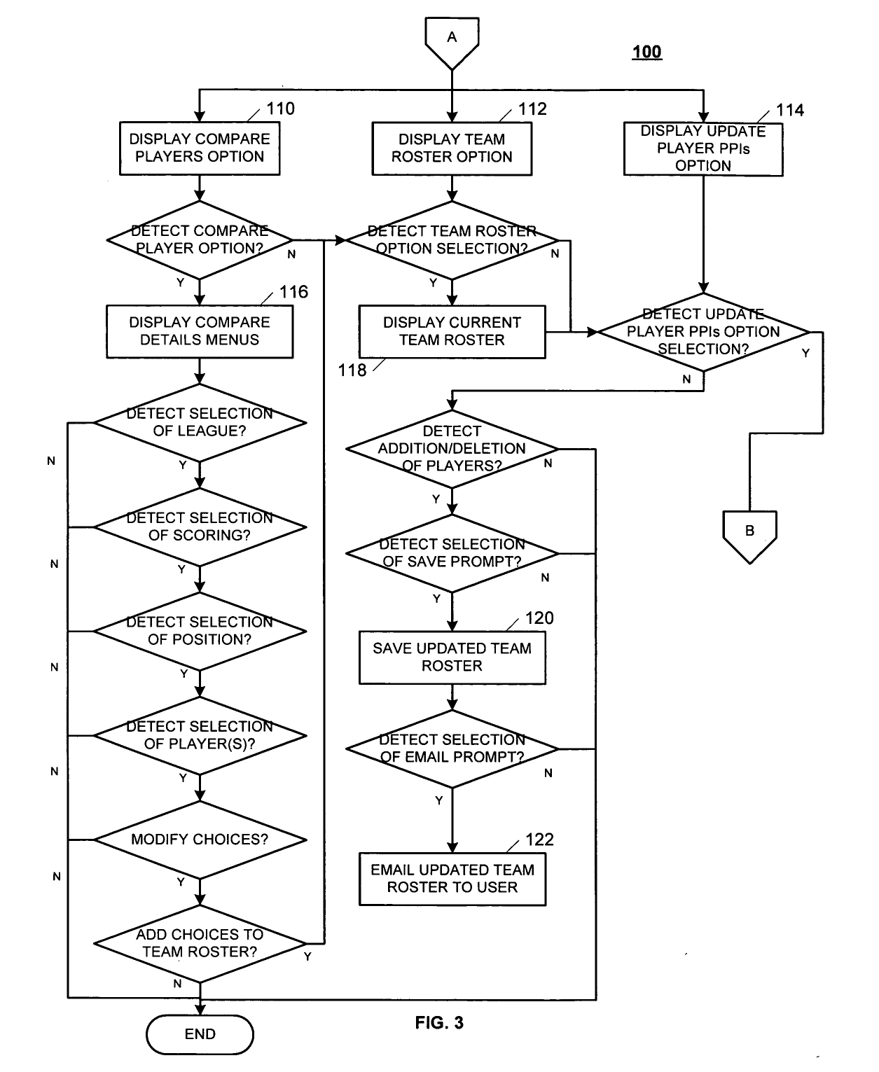

Referring again to FIG. 3, the user may bypass selection of the Compare Players option and instead directly select the Team Roster option from the Main Menu page. When the microcontroller 30 detects user selection of the Team Roster option displayed on the Main Menu page, the microcontroller 30 causes the user's current team roster to be displayed (step 118). If the user does not wish to edit his/her current team roster, he/she can simply choose to have updated PPIs associated with the players of his/her team roster to be displayed via user selection of the PPI Update prompt described above (step 124). The user may also bypass selection of both the Compare Player option and the Team Roster option and request a PPI update for the players on his/her current team roaster. When the microcontroller 30 detects user selection of the Updated Player PPIs option displayed on the Main Menu page, the microcontroller 30 calculates the PPIs for the players indicated in the team roster (step 124) and causes them to be forwarded to the display 21.

An individual player's data used to calculate the player's PPIs is updated periodically to align with game play. For example, in football, individual player data used to calculate the PPIs are updated weekly to align with the 16 weeks of game play. The PPIs are calculated using the individual player data and other game play data, and are based on a least-squares regression equation that most closely aligns with data corresponding to a player's past performance, and presumably predictive of a player's upcoming performance according to an embodiment of the invention.

Referring to FIG. 4, calculation or updating of an individual player's PPI begins when a least-squares regression equation is used to establish an individual player's Fantasy-Points equation (step 130). The player's past fantasy point scores and assigned values for a number of statistically weighted factors, X1,X2,X3, . . . X13, having coefficients that vary depending on the player's past accumulated performance, are used to determine the player's Fantasy-Points equation. Updating the Fantasy-Points equation yields new values for coefficients of the factors. Data and equations used to calculate or update the PPIs may be stored in the database 16 (see, FIG. 1).

For example, the least-squares regression equation may be expressed by the general equation:
Y=m₁(X1)+m₂(X2)+m₃(X3)+m₄(X4)+m₅(X5)+. . . m₁₃(X13)+B
where the least-squares regression equation calculates a straight line that best fits given data, and returns an array that describes the line.

The Fantasy-Points equation may be expressed by the equation:
FP=A+r₁(X1)+r₂(X2)+r₃(X3)+r₄(X4)+r₅(X5)+r₆(X6)+r₇(X7) +r₈(X8)+r₉(X9)+r₁₀(X10)+r₁₁(X11)+r₁₂(X12)+r₁₃(X13)
where FP=Fantasy points for an individual player

X1=Week of play

X2=Game venue (home or away)

X3=Opposition running yards allowed* /opponent's rushing defense

X4=Opposition passing yards allowed* /opponent's passing defense

X5=Opposition winning percentage*

X6=Rivalry game

X7=Game time temperature

X8=Game time wind speed

X9=Indoor or outdoor play

X10=Field surface (astroturf or grass)

X11=Precipitation level

X12=Player performance trend (momentum factor)

X13=Injury status

X14=Playing Time

A=Constant

where * indicates an average of a selected time period, and r₁,r₂,r₃, . . . r₁₃=correlation coefficients for each factor X1,X2,X3, . . . X13.

To obtain an updated Fantasy-Points equation for each player, the microcontroller 30 substitutes the fantasy point value accrued FP during the player's most recent game, substitutes values for the statistically weighted factors, X1,X2,X3, . . . X13 and solves for associated coefficients r₁,r₂,r₃, . . . r₁₃. Alternatively, an administrator using a statistical function such as Linest in Microsoft Excel may solve for the updated Fantasy-Points equation for the particular player.

The number and types of factors X1,X2,X3, . . . X13 in the Fantasy-Points equation may vary, depending on the game and the player's position. For example, in football, the number and types of factors X1,X2,X3, . . . X13 for a Quarterback may differ from the number and types of factors X1,X2,X3, . . . X13 for a Running Back, a Wide Receiver and a Tight End. For example, the factor for game time wind speed X8 may be included in determining the Fantasy-Points equation for a Quarterback, but not included in determining the Fantasy-Points equation for a Running Back. More over, the Fantasy-Points equation for a particular player will vary from periodic update to periodic update as the value of the associated coefficients r₁,r₂,r₃, . . . r₁₃ vary from periodic update to periodic update (e.g., from week to week).

As previously mentioned, the Fantasy-Points equation may be expressed as FP=A+r₁(X1)+r₂(X2)+r₃(X3)+r₄(X4)+. . . r₁₃(X13). For illustrative purposes, it is assumed that the player is a Quarterback. Substituting values for the game play factors X1,X2,X3, . . . X8 and a value for FP (the player's most recent fantasy point score), the microcontroller 30 yields a Quarterback specific Fantasy-Points equation of:
FP=66.3−0.63(X1)+2.35(X2)+0.19(X3)+r0.05(X4)−13.32(X5)−3.77(X6)−0.12(X7)−0.14(X8)
where the Fantasy-Points equation reflects the Quarterback's most recent game play data as well as past game play data associated with the game play factors X1,X2,X3, . . . X8. As will be appreciated by those skilled in the art, over time, weekly updates to the Quarterbacks Fantasy-Points equation will presumably yield more accurate values for the coefficients r₁,r₂,r₃, . . . r₁₃, and therefore yield a more accurate predictive ability of the Quarterback's upcoming play.

Referring again to FIG. 4, after calculating a particular player's Fantasy-Points equation, the microcontroller 30 calculates a Predicted Fantasy-Points value PFPvalue using the player's individual Fantasy-Points equation and values for the game play factors X1,X2,X3, . . . X8 (step 132). For example, referring again to the Quarterback example above, and using the Fantasy-Points equation,
FP=66.3−0.63(X1)+2.35(X2)+0.19(X3)+r0.05(X4) −13.32(X5)−3.77(X6)−0.12(X7)−0.14(X8)
and assuming that:

X1=5 Week of play

X2=0 Game venue (home or away)

X3=137 Opposition running yards /opponent's rushing defense

X4=224 Opposition passing yards /opponent's passing defense

X5=0.374 Opposition winning percentage

X6=1 Rivalry game

X7=55 Game time temperature

X8=12 Game time wind speed

The Quarterback's Predicted Fantasy-Points value PFPvalue equals 11.83. In other words, based on the Quarterback's past play record, the opposing team's record and upcoming play conditions, it is predicted that the Quarterback will earn 11.83 points during upcoming game play.

Next, the players PPI is calculated by normalizing the player's PFPvalue using a league average score LAP for all players having the same play position (step 134). The player's PPI may therefore be expressed as:
PPI=(PFP÷LAP)×100
Although preferably calculated by the microcontroller 30, it is contemplated that the player's PPI may be calculated by a user or an administrator using a player's Fantasy-Point equation and associated values for the factors of the equation.

The player's PPI may then be forward to a requesting user. When the microcontroller 30 detects user selection of the Email prompt via the Main Menu page, the microcontroller 30 causes one or more player PPI s to be displayed on the display 21. The PPI for the various players may then be compared by the user to build his/her team roster.

As may be apparent from the above discussion, the system and method for predicting a player's future performance based on a player's Performance Prediction Index (PPI), and for providing one or more player PPI(s) to a user, overcomes the problems associated with prior art online fantasy league play.

It is claimed:

1. A system for predicting a game play performance of a plurality of sports team players selected for fantasy game play, a winner of the fantasy game play determined by a fantasy points value, the system comprising:
a remote user device including a display; and
a host system operatively coupled to the remote user device via an access network, the host system including an application server and a database coupled to the application server, the application server configured to provide a plurality of numerical performance indexes to a user of the remote user device based on sport team player performance data and game play data, the plurality of numerical performance indexes predicting game play performance of the plurality of sports team athletes,
wherein the plurality of numerical performance indexes are utilized by the user to select a fantasy sports team roster for fantasy game play.

2. The system of claim 1, wherein the database is configured to store the sport team player performance data and game play data used by the application server to provide the plurality of numerical performance indexes.

3. The system of claim 1, where in the remote user device is selected from the group consisting of a personal computer, a mobile telephone and a personal digital assistant.

4. The system of claim 1, wherein the access network comprises the Internet.

5. The system of claim 1, wherein the application server comprises a microcontroller, the microcontroller including a microprocessor and a memory operatively coupled to the microprocessor, the microcontroller being programmed to:
determine a predictive game play equation for at least one player of the plurality of sports team players, the predictive game play equation based on a least-squares regression equation and including a sum of a number of game play factors wherein the sum of the number of game play factors is equal to fantasy points accrued by the at least one player during past game play, each of the number of game play factors having a corresponding variable coefficient, the predictive game play equation updated periodically causing each of the corresponding variable coefficients and the fantasy points value to vary;
calculate a predicted fantasy points value for the at least one player based on the predictive game play equation and values for the game play factors; and
normalize the predicted fantasy points value for the at least one player to form the numerical performance index for the at least one player.

6. The system of claim 5, wherein the game play factors are selected from the group consisting of a week of game play, a game play venue, a ratio of opposition game play running yards, a ratio of opposition game play passing yards, an opposition winning game percentage, a rivalry game play, a game time ambient temperature, game time wind speed, a game play arena location, a game play surface material, a game time precipitation, a player game play performance trend, and a player injury status.

7. The system of claim 5, wherein the microcontroller is further programmed to:
receive a user name and a user password from the user;
verify the user name and the user password against a database of authorized users;
cause a plurality of images to be transmitted to the display, the plurality of images enabling the user to access the plurality of numerical performance indexes and a portion of the game play factors; and
provide the plurality of numerical performance indexes and the portion of the game play factors to the user in response user requests.

8. The system of claim 7, wherein the microcontroller is further programmed to:
enable the user to establish the fantasy sports team roster selected by the user from the plurality of sports team players;
enable the user to modify the fantasy sports team roster based on respective numerical performance indexes of the team roster of players; and
save the fantasy sports team roster of players in the database in response to a save request from the user.

9. The method for predicting a game play performance of a plurality of sports team players selected for fantasy game play, a winner of the fantasy game play determined by a fantasy points value, the method comprising:
providing a host system accessible to a user having a remote user device including a display, the host system accessible to the remote user device via an access network operatively coupling the host system to the remote user device, the host system including an application server and a database coupled to the application server;
providing a plurality of numerical performance indexes to the user based on sport team player performance data and game play data, the plurality of numerical performance indexes predicting game play performance of the plurality of sports team athletes,
wherein the plurality of numerical performance indexes are utilized by the user to select a fantasy sports team roster for fantasy game play.

10. The method of claim 9, wherein the database is configured to store the sport team player performance data and game play data used by the application server to provide the plurality of numerical performance indexes.

11. The method of claim 9, where in the remote user device is selected from the group consisting of a personal computer, a mobile telephone and a personal digital assistant.

12. The method of claim 9, wherein the access network comprises the Internet.

13. The method of claim 9, further comprising:
determining a predictive game play equation for at least one player of the plurality of sports team players, the predictive game play equation based on a least-squares regression equation and including a sum of a number of game play factors wherein the sum of the number of game play factors is equal to fantasy points accrued by the at least one player during past game play, each of the number of game play factors having a corresponding variable coefficient, the predictive game play equation updated periodically causing each of the corresponding variable coefficients and the fantasy points value to vary;
calculating a predicted fantasy points value for the at least one player based on the predictive game play equation and values for the game play factors; and
normalizing the predicted fantasy points value for the at least one player to form the numerical performance index for the at least one player.

14. The method of claim 13, wherein the game play factors are selected from the group consisting of a week of game play, a game play venue, a ratio of opposition game play running yards, a ratio of opposition game play passing yards, an opposition winning game percentage, a rivalry game play, a game time ambient temperature, game time wind speed, a game play arena location, a game play surface material, a game time precipitation, a player game play performance trend, and a player injury status.

15. The method of claim 13, further comprising:
receiving a user name and a user password from the user;
verifying the user name and the user password against a database of authorized users;
causing a plurality of images to be transmitted to the display, the plurality of images enabling the user to access the plurality of numerical performance indexes and a portion of the game play factors; and
providing the plurality of numerical performance indexes and the portion of the game play factors to the user in response user requests.

16. The method of claim 15, further comprising:
enabling the user to establish the fantasy sports team roster selected by the user from the plurality of sports team players;
enabling the user to modify the fantasy sports team roster based on respective numerical performance indexes of the team roster of players; and
saving the fantasy sports team roster of players in the database in response to a save request from the user.
